(19) United States
(12) Patent Application Publication
(10) Pub. No.: US 2003/0215602 A1
(43) Pub. Date: Nov. 20, 2003

(54) Method and device for producing a multi-ply web of flexible material, such as paper and nonwoven, and multi-ply material and product produced by the method

(76) Inventors: Anders Andersson, Stenungsund (SE); Eva-Li Saarvali, Vastra Frolunda (SE)

Correspondence Address: YOUNG & THOMPSON, 745 SOUTH 23RD STREET 2ND FLOOR, ARLINGTON, VA, 22202

(21) Appl. No.: 10/373,025

(22) Filed: Feb. 26, 2003

Related U.S. Application Data
(60) Provisional application No. 60/359,337, filed on Feb. 26, 2002.

(51) Int. Cl. B32B 3/12

(52) U.S. Cl. 428/116

(57) ABSTRACT

Method for producing a multi-ply web of flexible material, such as paper and nonwoven material and a multi-ply product produced according to the method. A first pattern roll, having a three dimensional pattern of alternating raised and recessed portions transfers glue to a first web shaped flexible material in a first press nip in glue sites covering an area corresponding to between 0.03 and 9% of the total area of the first web material and sparsely distributed over substantially the entire area of the first web material. A second web shaped flexible material is brought in contact with the glue applied side of the first web material in a second press nip between a second pattern roll having a three-dimensional pattern corresponding to that of the first pattern roll, and an impression roll. The first and second pattern rolls are driven in registry.

### FIELD OF THE INVENTION

The present invention refers to a method for producing a multi-ply web of flexible material, such as paper and nonwoven material, by means of gluing the plies. Especially it refers to production of tissue products such as toilet and kitchen paper, paper towels, hand towels, napkins, handkerchiefs, wiping material and the like. The invention further refers to a multi-ply web of flexible material, such as paper and nonwoven, comprising at least a first and a second ply, which are interconnected by means of gluing in a glue pattern. The invention also refers to a product made from the multi-ply web.

### BACKGROUND OF THE INVENTION

It is very common to laminate two or more tissue plies in order to produce the final tissue product. Herewith a more flexible and softer tissue product is obtained as compared to if one single ply with a corresponding thickness and basis weight had been produced as for the laminated product. The absorbent capacity and the bulk are moreover improved.

The lamination of two or more tissue plies is often made by means of gluing. A mechanical embossing of the plies is also often performed before they are glued together. It is further known to laminate two plies only by means of a mechanical embossing, at which a mechanical joining of the plies occurs in the embossing sites.

Through for example EP-A-796 727 it is known to first emboss two paper plies in a three dimensional structure with alternating raised and recessed portions, after which glue is applied to one of the plies and the two plies are joined in a press nip between two embossing rolls, so that the raised portions of the respective plies are glued to each other. A similar embossing procedure is shown in EP-A-738 588, according to which the glue also has a colouring effect.

In WO 95/08671 there is enclosed an example of so called nested embossing, in which the two individually embossed plies are combined and joined with the raised portions of one ply nesting into the recessed portions of the opposite ply.

Through U.S. Pat. No. 5,443,889 there is known a procedure for laminating two paper plies, which are fed over a pattern roll each, said pattern rolls having alternating raised and recessed portions and where glue is applied to one ply while this is led over the roll. The two paper plies are then glued together in a nip between the two pattern rolls, which are in register with each other so that a joining and compression of the paper plies occurs in a pattern corresponding to the raised portions of the pattern rolls.

A drawback that occurs in connection with embossing a paper web where this is compressed in spots, is that a considerable strength reduction occurs in the embossing and glue sites, which effects the strength properties of the entire paper product. Strength reductions of up to 70% of an embossed paper as compared to a corresponding unembossed paper are not unusual.

U.S. Pat. No. 3,672,950 discloses a method for producing a quilted or cushioned adhesively laminated tissue product in which glue is applied in a certain pattern to one tissue ply in a press nip between a first pattern roll and an impression roll. This ply is laminated to another ply in a press nip between the same impression roll and a second pattern roll having a pattern corresponding with that of the first pattern roll and driven in registry with the first pattern roll. The two plies are in different conditions of stress during the lamination process, so that a quilted or cushioned product is provided.

### OBJECT AND SUMMARY OF THE INVENTION

The object of the present invention is to provide a method for producing a multi-ply web of flexible material, such as paper and nonwoven and combinations thereof, wherein at least two plies of flexible material are laminated together. The lamination should be lenient to the material so that the material structure of the plies is substantially maintained as well as its strength properties. The absorbent capacity and bulk of the finished product should moreover be high.

This has according to the invention been provided by bringing a first pattern roll, having a three dimensional pattern of alternating raised and recessed portions, in contact with a glue application device, applying glue to a first web shaped flexible material in a first press nip in a pattern corresponding to the configuration of the tops of the raised portions, the pattern configuration of the first pattern roll is chosen so that glue is applied to said first web shaped flexible material in glue sites covering an area corresponding to between 0.03 and 9% of the total area of the web shaped flexible material and sparsely distributed over substantially the entire area of the web shaped flexible material, a second web shaped flexible material being brought in contact with the glue applied side of said first web shaped flexible material in a second press nip between a second pattern roll having a three dimensional pattern of alternating raised and recessed portions corresponding to the pattern of said first pattern roll and an impression roll, the web tension of said first and second web shaped flexible materials are substantially equal as they are fed into the second press nip, the first and second pattern rolls being in registry with each other, so that the first and second web shaped flexible materials are pressed and glued together in a pattern corresponding to the configuration of the tops of the raised portions of said first pattern roll.

Through this procedure there will be no real embossing of the material web in connection with the lamination, but only a gluing together of the plies in a glue pattern. A strength reduction of the final product is herewith avoided at the same time as a volume is created between the plies between the glue sites, which increases the bulk and absorption capacity. The bulk from the separate plies is further substantially maintained after the lamination process.

According to a one embodiment the glue is a coloured glue.

In one embodiment of the invention at least one of the plies before lamination with the opposite ply is exerted to a three-dimensional patterning.

According to a further embodiment at least two plies before lamination is exerted to a three dimensional patterning, the patterns provided on the at least two plies having different structures, for example one pattern being relatively fine and another pattern being relatively coarse.

According to still a further embodiment at least one ply is reinforced with strings of glue or curing bonding agent, for example latex. The curing agent is cured after lamination.

The size of each glue site should amount to between 0.15 and 150, preferably between 0.5 and 110 mm², more preferably between 1 and 15 mm². In an alternative embodiment the size of each glue site amounts to between 150 and 400 mm². The number of glue sites per area unit should amount to between 25 and 350,000, preferably between 300 and 180,000 and more preferably between 800 and 50,000 glue sites per m². It is pointed out that the glue sites may be regularly distributed over the area of the web shaped material, but they may also be irregularly distributed, for example arranged in groups spaced apart.

The term spots in this respect refers to any shape of the glue sites, such as small points, lines, figures, letters, phantasy patterns or any desired shape.

The invention further refers to a multi-ply web of flexible material, such a paper and nonwoven, comprising at least one first and one second ply which are interconnected by gluing in glue sites forming a glue pattern, wherein the glue sites cover an area corresponding to between 0.03 and 9% of the total area of the ply and sparsely distributed over substantially the entire area of the ply and that one external surface of said multi-ply web just opposite the glue sites has substantially no and the opposite external surface of said multi-ply web has slight compacting impressions in the material provided in connection with the joining of the plies.

Further features of the invention are disclosed in the following description and in the claims.

### BRIEF DESCRIPTION OF THE DRAWINGS

The invention will in the following be closer described with reference to an embodiment shown in the accompanying drawings.

FIG. 1 shows a schematic side view of a device for performing the method according to the invention.

FIG. 2 is a schematic cross section of an embodiment of a two-ply paper produced according to the method.

FIG. 3a-c are plan views of some glue patterns on a paper ply according to the invention.

FIG. 4 is a schematic cross section of an embodiment of a three-ply paper according to the invention.

### DETAILED DESCRIPTION OF THE INVENTION

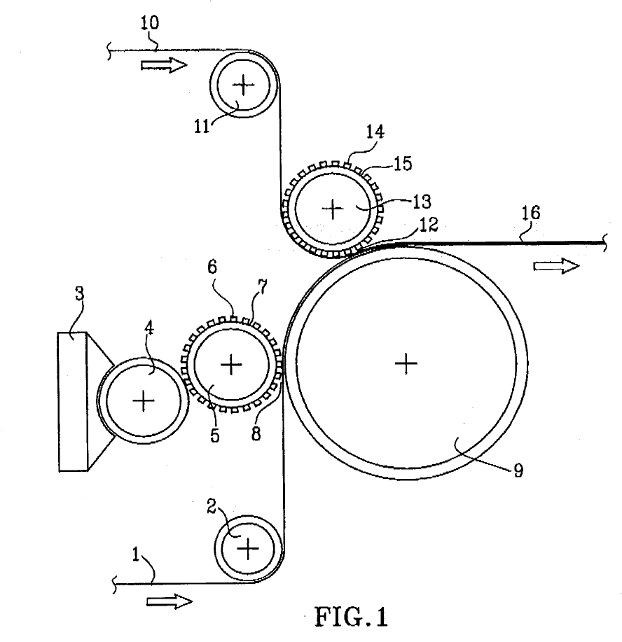

FIG. 1 shows a device for producing a two-ply material, e.g. paper, especially tissue paper. A first paper web 1 is fed over a roll 2 towards a glue application station. This comprises a glue chamber 3 from which glue is applied on a glue transfer roll 4. The glue transfer roll 4 is in contact with a first pattern roll 5, which along its periphery is provided with a pattern of alternating raised 6 and recessed portions 7. The glue transfer roll 4 is only contacting the tops of the raised portions 6, so that glue is only applied thereon. The paper web 1 is passed into a press nip 8 between the first pattern roll 5 and a centrally placed impression roll 9. Glue will thus be applied to the first paper web 1 in a pattern corresponding to the configuration of the tops of the raised portions 6. The pressure in the press nip between the pattern roll 5 and the impression roll 9 is only sufficiently high to accomplish a transfer of glue to the paper web 1. However there should preferably be no deformation of the paper web, i.e. no impression of the raised portions 6 of the pattern roll 5 into the paper web.

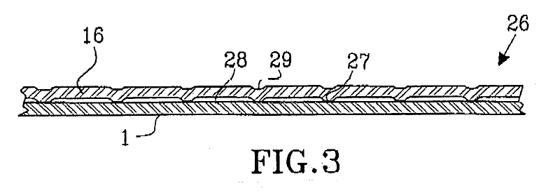

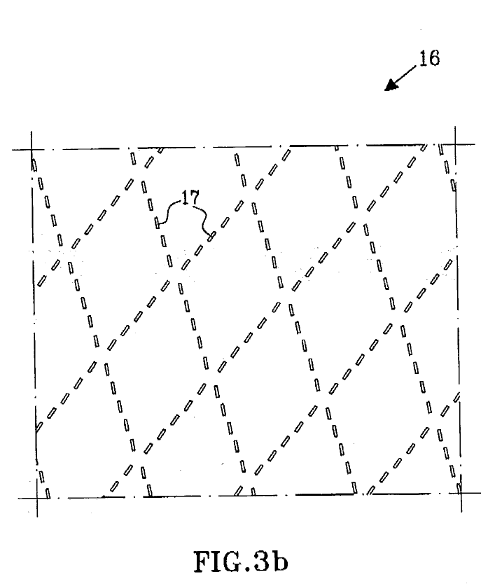

A second paper web 10 is fed over a roll 11 and into a press nip 12 between a second pattern roll 13 and the centrally placed impression roll 9. The second pattern roll 13 has a three dimensional pattern of raised 14 and recessed portions 15 corresponding to the pattern of the first pattern roll 5. The term “corresponding to” in this respect means that the raised portions 14 either have the same shape and size of the effective surface area as the raised portions 6 of the first pattern roll 5, the same shape but a larger effective surface area than the raised portions 6 of the first pattern roll 5 so as to extend outside the outer circumference of the glue sites provided by the first pattern roll 5 or a different shape and a larger effective surface area than the raised portions 6 of the first pattern roll 5. For example a glue pattern provided by the first pattern roll 5 may be in the form of groups of three dots arranged in a triangular pattern as shown in FIG. 3a, wherein the raised portions 14 of the second pattern roll 13 may either be exactly the same as or slightly larger than the glue pattern, or may for example be in the form of a triangle 20 covering the three dots. In all these cases the relative position of the pattern on the two pattern rolls 5 and 13 are in correspondence with each other.

The web tension of said first and second plies 1 and 10 are substantially equal as they are fed into the second press nip 12. Herewith there will be no foreshortening effect from the lamination. The two pattern rolls 5 and 13 are driven in registry with each other so that the first and second paper webs 1 and 10 are pressed and glued together in a pattern corresponding to the configuration of the glue pattern provided by the first pattern roll 5.

It is preferred that one centrally impression roll 9 is used for both the first and second pattern rolls 5 and 13, as is shown in FIG. 1. However it would of course also be possible to use two separate impression rolls for the first and second pattern roll 5 and 13, and to synchronize them so that they are driven in registry.

Also in this second press nip the pressure should be low and only sufficiently high to provide a gluing together of the two paper webs 1 and 10. The pressure in the second press nip should not be higher than to cause only slight compacting impressions 19 just opposite the glue sites in the second ply 10 facing the second impression roll 13.

The opposite external surface of said multi-ply web, i.e. the surface facing the central impression roll 9 will substantially maintain its structure unaffected by the lamination process with no compacting impressions in the material opposite the glue sites. The laminated multi-ply product is denoted 16.

The pattern on the two pattern rolls 5 and 13 can be optional, but should be chosen so that glue is applied to the paper web 1 in an amount corresponding to between 0.03 and 9%, preferably between 0.1 and 6% the total surface area of the paper web 1. In the present case the glue sites are sparsely distributed over substantially the entire area of the laminated product. It is with the method according to the invention possible to provide a very distinct positioning of the glue sites, wherein a very small amount of glue is needed. This means advantages with respect to softness, drapability, absorption etc. In the case that the glue pattern comprises a plurality of discrete glue sites the number of glue sites per area unit should amount to between 25 and 350,000 glue sites per m², preferably between 300 and 180,000 glue sites per m² and more preferably between 800 and 50,000 glue sites per m². According to one embodiment the size of each glue site amounts to between 0.15 and 150 mm², preferably between 0.5 and 100 mm² and more preferably between 1 and 15 mm². According to an alternative embodiment the size of each glue site amounts to between 150 and 400 mm², which applies for certain composite glue patterns comprising thin lines, e.g. 1 mm in width, forming for example a symbol or a figurative pattern. In such an embodiment the number of glue sites per m² will be in the lower part of the above interval, for example less than 800.

In the case of large glue sites screened patterns can be used, which means that each glue pattern unit is built up of a plurality of small screen dots. The size of the glue site in this case is defined as the circumscribed area of the combination of screen dots forming a glue pattern unit.

According to a further embodiment the glue pattern is composed of continuous lines forming for example a network.

Preferred glues are the ones commonly used for paper, such as carboxy methyl cellulose (CMC), polyvinyl alcohol (PVOH), ethylene vinyl acetate (EVA), polyvinyl acetate (PVAc), ethylene acrylic acid, vinyl acetate acrylic acid, styrene acrylic acid, polyurethane, polyvinylindene chloride, starch, chemically modified starch, dextrin, water soluble polymers such as latexes and milky colloids in which natural or synthetic rubber or plastic is suspended un water. In case the material webs are of other material than paper glues suited for these materials are of course chosen.

It is preferred to use glues having a relatively high dry content, since this enables a distinct positioning of the glue sites.

Coloured glues may also be used, which give a visual effect and therewith a patterning effect to the material.

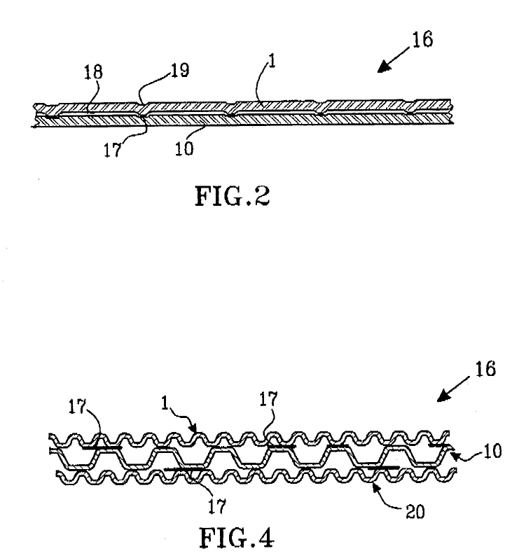

In FIG. 2 there is shown an example of a two-ply paper produced according to the invention, at which the glue sites between the two paper plies 1 and 10 are denoted 17. Between the glue sites 17 the paper plies 1 and 10 are free and not attached to each other and empty spaces 18 are created which increase the bulk and absorption capacity of the material, properties that are important for e.g. soft paper. Substantially the entire bulk from the separate plies is maintained after the lamination. The second paper web 10 can have just opposite the glue sites slight compacting impressions 19 caused by the pattern roll 13.

FIG. 3a-c show some examples of glue patterns, wherein discrete glue sites 17 in the form of dots or lines are arranged to form different patterns. The glue sites 17 may also be in the form of continuous lines for example forming a network pattern.

The paper webs 1 and 10 that are laminated can be either smooth or also have a three-dimensional structure provided earlier in the process, for example during forming, dewatering and/or drying of the paper web. A three-dimensional structure may also be provided by embossing the dry paper webs before lamination. The method according to the invention is very lenient to such a pattern, so that this is maintained substantially intact throughout the laminating process.

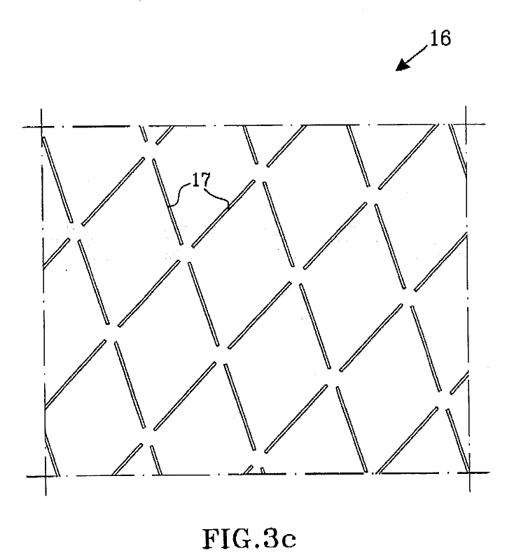

FIG. 4 shows an embodiment of a three-ply paper in which the plies 1, 10 and 20 before lamination have been exerted to a three dimensional patterning, for example embossing. The structures of the embossing patterns are different, so that the pattern structure of the middle ply 10 is coarser than that of the two outer plies 1 and 20. A high-bulk product is then obtained. The glue sites 17 between plies 1 and 10 may, as disclosed, be applied offset with respect to the glue sites between plies 10 and 20, or be applied just opposite each other. Other combinations of different embossing patterns may of course be used than what is shown in FIG. 4. Multi-ply products having different structures on opposite sides may be created if the two outer plies have different embossing structures, such as one coarser side and one smoother side. So called micro quilted embossing patterns may also be used. One or more plies may further be unembossed. In the case of a two-ply product a two-sided product is obtained if one ply is embossed and the other unembossed or have a different embossing structure.

The embossing patterns used for the different layers may also be the same. In this case the plies may be embossed jointly and then separated from each other before being laminated by the method according to the invention. They may also be separately embossed before lamination.

An important advantage of the invention is that the paper substantially maintains its strength properties through the lamination process. In many other lamination processes, in which an embossing and deformation of the paper webs occur in connection with lamination, the strength properties are decreased. In case the laminated multiply web has a substantially smooth structure it can be converted into dense rolls or folded products, which means space and cost savings.

The laminated multiply product may also if desired, due to the strong ply bonding provided by the glue spots, be embossed after the lamination process, thereby creating a softer material. The effective ply bonding is achieved due to the distinct gluing effect provided by the second pattern roll 13 driven in registry with the glue transfer roll 4. This ply bonding effect is not reduced when converting, for example rolling, the paper product, which may be the case for ply bonding provided by embossing.

Three or more paper plies may of course be laminated with the method described above.

Thus two or more plies may enter the first and/or second press nip.

Different kind of paper with different properties with respect to absorption capacity, basis weight, manufacturing technique, fiber composition, chemical additives may be used in the different plies.

The method is further suitable to use for paper plies having holes therein, since the main part of the holes will be intact throughout the lamination process and not be filled with glue, which normally is the case when gluing the plies together.

At least one paper ply may further be reinforced with thin strings of glue or a curing bonding agent, such as latex. The glue strings may be effected for example by spray guns or via a roller. The reinforcement may for example take place on the outside of the laminated product after lamination and in register with the lamination process. The reinforcement may alternatively take place on the inside before or during the lamination, preferably in register. In the case of a curing bonding agent the paper product is cured after lamination, for example by heat treatment. When reinforcing the paper plies in this manner, very thin materials may be used, which otherwise would not have been possible to use, because of an insufficient strength to be handled in the converting process or in a dispenser.

The multi-ply web may be converted to any desired product, such as rolls, folded hand towels, wipes, handkerchief, napkins etc. It would be of advantage to use the multi-ply web according to the invention in so called center-feed coreless rolls, in which the paper is taken from the center of the roll. For a conventional multi-ply web in which joining of the plies is connected with embossing, the innermost revolutions, which are compressed rather hard so that the embossing is more or less destroyed, will not come out as a satisfactory product. In the multi-ply web according to the invention, on the other hand, lamination of the plies is separated from any patterning effect provided by embossing or the like and thus also the innermost revolutions of the coreless roll will form a useful product.

1. Method for producing a multi-ply web of flexible material having at least one first ply and one second ply by gluing the plies, which comprises:
bringing a first pattern roll, having a three dimensional pattern of alternating raised and recessed portions, in contact with a glue application device;
applying glue to a first web shaped flexible material in a first press nip in a pattern corresponding to the configuration of the tops of the raised portions, the pattern configuration of the first pattern roll being chosen so that glue is applied to said first ply in glue sites covering an area corresponding to between 0.03 and 9% of the total area of the first web shaped flexible material and sparsely distributed over substantially the entire area of the first web shaped flexible material;
bringing a second web shaped flexible material in contact with the glue applied side of said first web shaped flexible material in a second press nip between a second pattern roll having a three dimensional pattern of alternating raised and recessed portions corresponding to the pattern of said first pattern roll and an impression roll; wherein the web tension of said first and second plies are substantially equal as they are fed into the second press nip the first and second pattern rolls being in registry with each other, so that the first and second first web shaped flexible materials are combined and glued together in a pattern corresponding to the configuration of the tops of the raised portions of said first pattern roll.

2. Method as claimed in claim 1, wherein glue is applied to said first ply in glue sites covering an area corresponding to between 0.1 and 6% of the total area of the first web shaped flexible material.

3. Method as claimed in claim 1, wherein the pattern provided by the raised portions of the second pattern roll has a larger area than that provided by the raised portions of the first pattern roll, so that the pattern of the second pattern roll extends outside the glue sites provided by the first pattern roll.

4. Method as claimed in claim 1, wherein the glue is a coloured glue.

5. Method as claimed in claim 1, wherein at least one of the plies before lamination with the opposite ply is exerted to a three dimensional patterning provided on the ply while wet, during drying of the wet ply or in a dry state.

6. Method as claimed in claim 5, wherein at least two plies before lamination are exerted to a three dimensional patterning, the patterns provided on said at least two plies having different structures, one pattern being relatively fine and another pattern being relatively coarse.

7. Method as claimed in claim 1, further comprising reinforcing at least one ply with strings of glue or curing bonding agent.

8. Method as claimed in claim 7, further comprising curing said bonding agent after lamination.

9. Method as claimed in claim 1, wherein the size of each glue site amounts to between 0.15 and 150 mm².

10. Method as claimed in claim 1, wherein the size of each glue site amounts to between 150 and 400 mm².

11. Method as claimed in claim 1, wherein the number of glue sites per unit area amounts to between 25 and 350,000 glue sites per m².

12. Multi-ply web of flexible material, comprising at least one first and one second ply which are interconnected by gluing in glue sites forming a glue pattern, wherein the glue sites cover an area corresponding to between 0.03 and 9% of the total area of the ply and sparsely distributed over substantially the entire area of the ply and that one external surface of said multi-ply web just opposite the glue sites has substantially no and the opposite external surface of said multi-ply web has slight compacting impressions in the material provided in connection with the joining of the plies.

13. Multi-ply web as claimed in claim 12, wherein the glue sites take up a total area of between 0.1 and 6% of the total surface area of the respective ply.

14. Multi-ply web as claimed in claim 12, the size of each glue site amounts to between 0.15 and 150 mm².

15. Multi-ply web as claimed claim 12, wherein the size of each glue site amounts to between 150 and 400 mm².

16. Multi-ply web as claimed in claim 12, wherein the glue in the glue sites is coloured.

17. Multi-ply web as claimed in claim 12, wherein at least one of the plies has a three-dimensional pattern provided before joining with the opposite ply.

18. Multi-ply web as claimed in claim 17, wherein at least two plies have a three-dimensional pattern provided before joining with the opposite ply, the patterns provided on said at least two plies having different structures, one pattern being relatively fine and another pattern being relatively coarse.

19. Multi-ply web as claimed in claim 17, wherein the multi-ply web has one external side with a relatively coarse three-dimensional structure and one external side with a relatively smooth structure.

20. Multi-ply web as claimed in claim 17, wherein the multi-ply web has at least three plies, with one middle ply having a relatively coarse three-dimensional structure.

21. Multi-ply web as claimed in claim 12, wherein at least one ply is reinforced with strings of glue or curing bonding agent.

22. Multi-ply web as claimed in claim 12, wherein at least one of the plies has holes therein.

23. A roll, folded towel, wipe, handkerchief, napkin of web-shaped material, wherein said web-shaped material is a multi-ply web as claimed in claim 12.

24. A roll of web-shaped material as claimed in claim 23, wherein said roll is a center-feed coreless roll.

25. A product of web-shaped material as claimed in claim 23, wherein said web-shaped material is tissue paper.
